(19) United States
(12) Patent Application Publication
(10) Pub. No.: US 2003/0155220 A1
(43) Pub. Date: Aug. 21, 2003

(54) Wall light switch cover

(76) Inventor: Yong Min Cho, Silver Spring, MD (US)

Correspondence Address: Mr. Yong Min Cho, 16605 Sea Island Court, Silver Spring, MD, 20905, US

(21) Appl. No.: 10/078,436

(22) Filed: Feb. 21, 2002

(51) Int. Cl. H01H 9/28

(52) U.S. Cl. 200/43.01

(57) ABSTRACT

When a person is having guests over, there may be some light switches that they may not want their guests to touch. The switch may turn on a light outdoors, or it may turn on another light that the host may not want turned on. If the guest forgets to turn off the light switch, the light that it turned on will be wasting electricity and it may even burn out the bulb. It is easily installed, and it sends the message that the light switch is not to be touched.

The wall light switch cover can prevent a child from turning on a dangerous electrical appliance, or some other device hazardous to their well-being.

The wall light switch cover is a useful invention that prevents light switches from being turned on and off. However, because one side is left open, the proper persons can turn on and off the light switch. The cover sends a blatant message to adults that the light switch should not be touched.

### BACKGROUND OF THE INVENTION

The Wall Light Switch Cover is an efficient way of preventing a light switch from being turned on. When people have guests over, the Wall Light Switch Cover can prevent the guests from turning on lights or appliances that the host does not want turned on. The Wall Light Switch Cover can also prevent young children from turning on dangerous electrical appliances, or other devices hazardous to their well-being. The Wall Light Switch Cover can protect young children and prevent accidents.

### SUMMARY OF THE INVENTION

The primary objective of this invention is to provide an easily installable cover for a standard toggle wall light switch that prevents certain lights and appliances from being turned on, or in some cases, from being turned off. The Wall Light Switch Cover is made out of clear plastic. The edges of the Wall Light Switch Cover are sanded down to dull the sharp edges and provide safety. Because one side of the cover is left open, those people who have the authority to turn on the switch will be able to have access to it. The Wall Light Switch Cover will save people the hassle of having to make sure certain switches are kept on or off by clearly showing people that the light is not to be touched.

### BRIEF DESCRIPTION OF THE DRAWING

This invention can be fully understood through references to the following four figures and their brief descriptions below:

FIG. 1 is the side view of the wall light switch cover.

FIG. 2 is the top view of the wall light switch cover.

FIG. 3 is the standard toggle wall light switch.

FIG. 4 is the installed wall light switch cover over the standard toggle wall light switch.

### DETAILED DESCRIPTION OF THE DRAWING

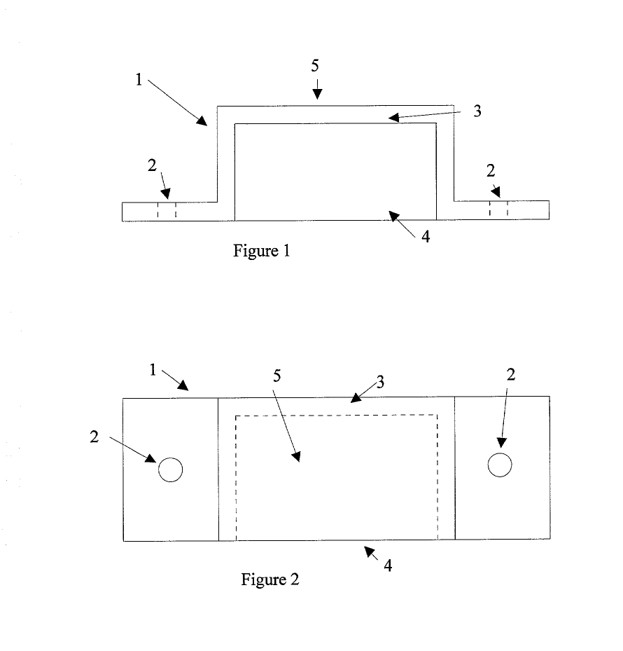

In FIGS. 1 and 2, the wall light switch cover 1 has two screw holes 2 at the sides, which line up with the screw holes of the standard toggle wall light switch. The wall light switch cover 1 is covered on the top 5 and one of the sides 3, leaving the other side 4 open.

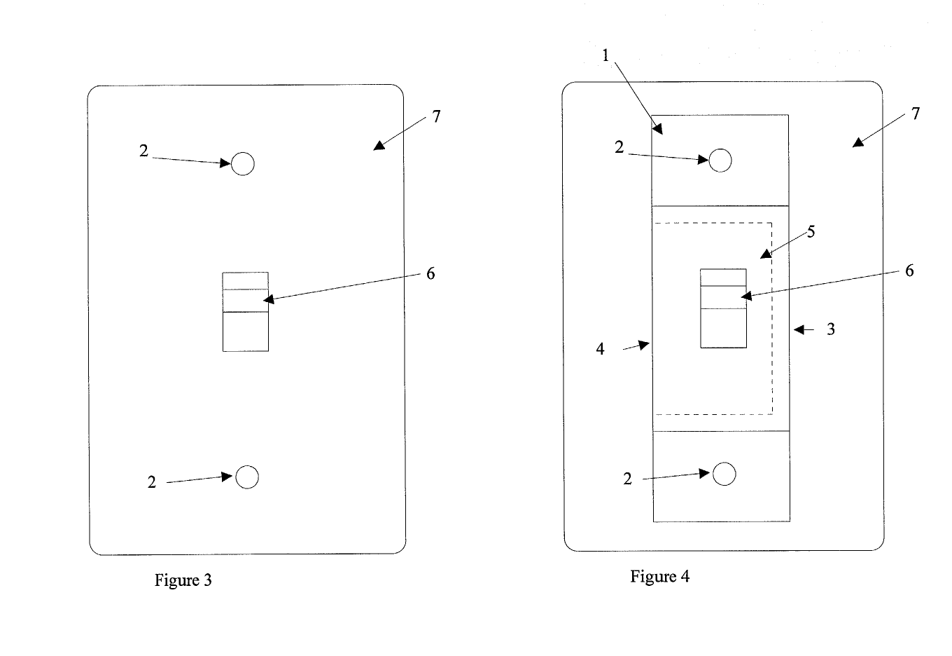

In FIG. 3, a standard toggle wall light switch 7 has a switch 6 and two screw holes 2.

In FIG. 4, the wall light switch cover 1 is installed over a standard toggle wall light switch 7. The box formed by the top 5 and side 3 of the cover is centered over the light switch 6. The open side of the box 4 allows minimal access to the light switch 6. The wall light switch cover 1 is installed by lining up the screw holes 2 and placing screws in them.

I claimed:

1. Any size and shape of a wall light switch cover, which always has a closed top and one closed side, with one side left open, allowing minimal access to the standard toggle wall light switch.

2. A wall light switch cover of claimed 1 that uses the existing holes in a standard toggle wall light switch plate in the installation process.

3. Any materials used to produce claimed 1.
